(19) United States
(12) Patent Application Publication
(10) Pub. No.: US 2026/0254015 A1
(43) Pub. Date: Aug. 27, 2026

(54) BATTERY PACK AND PACK CASE

(71) Applicant: LG ENERGY SOLUTION, LTD., Seoul (KR)

(72) Inventors: Hyuk-Kyun CHANG, Daejeon (KR); Soo-Youl KIM, Daejeon (KR)

(73) Assignee: LG ENERGY SOLUTION, LTD., Seoul (KR)

(21) Appl. No.: 19/545,646

(22) Filed: Feb. 20, 2026

(30) Foreign Application Priority Data
Feb. 21, 2025 (KR) 10-2025-0022942
Feb. 6, 2026 (KR) 10-2026-0024623

(51) Int. Cl. H01M 50/204; H01M 10/6556; H01M 10/6567; H01M 50/172; H01M 50/183; H01M 50/249; H01M 50/271; H01M 50/30

(52) U.S. Cl. CPC H01M 50/204; H01M 10/6556; H01M 10/6567; H01M 50/172; H01M 50/183; H01M 50/249; H01M 50/271; H01M 50/394; H01M 2220/20

(57) ABSTRACT

A battery pack according to one embodiment of the present disclosure may include: a bottom cover assembly including a communication hole formed in an upper surface thereof, a discharge passage in communication with the communication hole, and a first cooling passage; a battery cell positioned above the bottom cover assembly; a top cover assembly positioned above the battery cell and including an injection hole formed in a lower surface thereof and a second cooling passage in communication with the injection hole; and a hole cover coupled to the lower surface of the top cover assembly and sealing the injection hole.

### CROSS-REFERENCE TO RELATED APPLICATIONS

This application is based on and claims priority from Korean Patent Application No. 10-2025-0022942 filed on February 21, 2025, with the Korean Intellectual Property Office, and Korean Patent Application No. 10-2026-0024623, filed on February 6, 2026, with the Korean Intellectual Property Office, the disclosures of which are incorporated herein in their entirety by reference.

### TECHNICAL FIELD

The present disclosure relates to a battery pack and a pack case.

### BACKGROUND

As the demand for portable electronic products such as smartphones, tablet PCs, and smart watches significantly increases, and electric vehicles have become gradually widespread, research on the batteries mounted on these products including the electric vehicles, particularly, on the secondary batteries that are repeatedly chargeable and dischargeable, is actively being conducted.

Currently commercially available secondary batteries include nickel cadmium batteries, nickel hydrogen batteries, nickel zinc batteries, lithium secondary batteries, and the like. Among them, the lithium secondary batteries are subject to little memory effect compared to nickel-based secondary batteries, and thus, are receiving a lot of attention due to advantages such as free charging/discharging, a very low self-discharge rate, and a high energy density.

The lithium secondary batteries mainly uses a lithium-based oxide and a carbon material as a positive electrode active material, and a negative electrode active material, respectively. The lithium secondary batteries include an electrode assembly, and an external material that seals and accommodates the electrode assembly with an electrolyte, that is, a battery case. In the electrode assembly, a positive electrode plate and a negative electrode plate, which are coated with the positive electrode active material and the negative electrode active material, respectively, are disposed with a separator interposed therebetween.

In general, according to the shape of the external material, the lithium secondary batteries may be classified into can-type secondary batteries, in which the electrode assembly is accommodated in a metal can, and pouch-type secondary batteries, in which the electrode assembly is housed in a pouch of an aluminum laminate sheet.

The secondary batteries have recently been widely used for driving or energy storage not only in small devices such as portable electronic devices, but also in medium- to large-sized devices such as electric vehicles and energy storage systems (ESSs). A plurality of such secondary batteries may be accommodated together in a module case while being electrically connected to each other, thereby constituting a single battery module. Here, each secondary battery included in the single battery module may be referred to as a battery cell. Then, a plurality of such battery modules may be connected to each other to constitute a battery pack.

However, when a plurality of battery modules are included inside the battery pack, and a plurality of battery cells are included in each battery module in this manner, there may be a vulnerability to a thermal chain reaction between battery modules or battery cells. For example, when an event such as thermal runaway occurs within one battery module, such thermal runaway needs to be suppressed from propagating to other battery modules or other battery cells. When thermal runaway propagation between battery modules or battery cells is not properly suppressed, there is a risk that an event occurring in a specific battery module or battery cell may cause a chain thermal reaction in other battery modules or other battery cells, thereby causing an explosion or a fire or increasing the scale of the chain thermal reaction thereof.

In particular, when an event such as thermal runaway occurs in one battery module, the gas, flames, and the like, may be randomly emitted to the outside. Here, when the emission of gas or flames is not properly controlled, there is a risk that the gas or flames may be emitted toward other battery modules, thereby causing a thermal chain reaction in other battery modules. In particular, on the front side of the battery module, a module terminal exists, and then there may be a configuration for electrical connection to another battery module or another battery pack, that is, a module busbar. Therefore, when flames are emitted to the front side of such a battery module, the module terminal may be damaged in the battery pack and an electrical short may be caused. Also, since another battery module may be present on the front side of the battery module, when flames are emitted to the front side of a specific battery module, the emitted flames may be directed to the other battery module, thereby easily causing fire propagation between battery modules.

When thermal propagation occurring between battery modules or battery cells is not properly controlled, a voltage drop may rapidly occur in the battery module or the battery pack. Then, this may lead to a sudden shutdown of a device equipped with the battery module or the battery pack, thereby causing an unexpected damage. For example, when a voltage drop of a battery pack suddenly occurs during operation of an electric vehicle, it is not possible to ensure enough time to move the electric vehicle to a safe location.

Furthermore, when a fire or an explosion suddenly occurs because thermal propagation between battery modules or battery cells is not properly controlled, there is a high possibility of casualties among the users. For example, when thermal runaway occur in an electric vehicle, occupants may not be able to safely escape when a sufficient amount of time is not secured before the fire is fully developed.

### SUMMARY

The present disclosure provides a battery pack, a pack case and a vehicle including the same, in which the structure of the battery pack is improved such that, for example, emission of flames, generated within a battery module may be properly controlled.

The present disclosure provides a structure in which when a thermal event occurs, it is possible to quickly inject a cooling liquid into a battery module.

The present disclosure provides a structure in which it is possible to suppress heat propagation between battery cells or battery modules.

The present disclosure provides a structure in which a cooling liquid injected into a battery module may be discharged to the outside of the battery module.

The present disclosure provides a structure in which even when a thermal event occurs, a cooling function may be maintained.

Meanwhile, the technical problems to be solved by the present disclosure are not limited to the above-mentioned problems, and other unmentioned problems will be clearly understood by those skilled in the art from the description of the invention described below.

A battery pack according to one embodiment of the present disclosure may include: a bottom cover assembly including a communication hole formed in an upper surface thereof, a discharge passage in communication with the communication hole, and a first cooling passage; a battery cell positioned above the bottom cover assembly; a top cover assembly positioned above the battery cell and including an injection hole formed in the lower surface thereof and a second cooling passage in communication with the injection hole; and a hole cover coupled to the lower surface of the top cover assembly and sealing the injection hole.

The battery pack may further include a first cooling liquid disposed in the first cooling passage.

The battery pack may further include: a side wall provided in the bottom cover assembly; and a venting device provided in the side wall. The discharge passage may communicate with the venting device.

The battery pack may further include a second cooling liquid disposed in the second cooling passage.

The communication hole may face the battery cell.

The injection hole may be positioned above the battery cell.

The discharge passage and the first cooling passage may be configured independently.

The battery pack may further include a module case that is positioned between the bottom cover assembly and the top cover assembly, and provides a space therein. The battery cell may be accommodated inside the module case.

The module case may have an inflow hole formed on the upper surface thereof and facing the hole cover.

The module case may have a venting hole formed on the lower surface thereof and communicating with the communication hole.

The venting hole may face the battery cell.

The battery cell may include: a housing portion including an electrode assembly; a sealing portion extending from the housing portion; and an electrode lead protruding from the sealing portion. The venting hole may be positioned under the sealing portion.

The pack case according to another embodiment of the present disclosure is a pack case capable of accommodating a battery pack therein. The pack case includes a bottom cover assembly and a top cover assembly coupled to the bottom cover assembly, on the bottom cover assembly. The bottom cover assembly includes: a communication hole formed in an upper surface thereof; a discharge passage in communication with the communication hole; and a first cooling passage configured to allow a first cooling liquid to flow therethrough. The top cover assembly includes: an injection hole formed in the lower surface thereof and configured to allow a second cooling liquid to be injected into the battery pack accommodated in the lower portion; and a second cooling passage in communication with the injection hole. Then, the top cover assembly includes a hole cover coupled to the lower surface thereof and sealing the injection hole.

The hole cover includes a material having a melting point of a specific temperature or less.

The hole cover includes polylactic acid (PLA).

The discharge passage provided in the bottom cover assembly is connected to an outside via a venting device and allows venting gas G flowing into the discharge passage, to be discharged to the outside.

The vehicle according to an aspect of the present disclosure includes the battery pack of the present disclosure.

According to at least one of embodiments of the present disclosure, when a thermal event occurs, the cooling liquid may be quickly injected into the battery module.

According to at least one of embodiments of the present disclosure, the thermal stability of the battery pack may be improved.

According to at least one of embodiments of the present disclosure, the electrical safety of the battery pack may be improved.

According to at least one of embodiments of the present disclosure, when a thermal event occurs, heat propagation between battery modules may be suppressed.

According to at least one of embodiments of the present disclosure, even when a thermal event occurs, a cooling function may be maintained.

### BRIEF DESCRIPTION OF THE DRAWINGS

The following drawings attached hereto illustrate embodiments of the present disclosure and serve to further understand the technical idea of the present disclosure together with the content of the disclosure described above. Therefore, the present disclosure should not be construed as being limited to the matters illustrated in the drawings.

FIG. 1 is a view illustrating a battery pack according to one embodiment of the present disclosure.

FIG. 2 is a view of the battery pack of FIG. 1, in which some of the components are disassembled.

FIG. 3 is a view of the battery pack of FIG. 2, in which some of the components are disassembled.

FIG. 4 is a view illustrating a top cover assembly of FIG. 3.

FIG. 5 is a view of the top cover assembly of FIG. 4, in which some of the components are disassembled.

FIG. 6 is a view of the portion D of FIG. 5, in an enlarged scale.

FIG. 7 is a bottom perspective view of FIG. 5.

FIG. 8 is a bottom perspective view of the top cover assembly of FIG. 4.

FIG. 9 is a view illustrating a cross-sectional configuration taken along the cutting line B-B' in FIG. 4.

FIG. 10 is a view illustrating a cross-sectional configuration taken along the cutting line C-C' in FIG. 4.

FIG. 11 is a view illustrating a support of FIG. 3.

FIG. 12 is a view illustrating a battery module of FIG. 3.

FIG. 13 is a view of the battery module of FIG. 12, in which some of the components are disassembled.

FIG. 14 is a view illustrating some of the components of the battery pack of FIG. 3.

FIG. 15 is a view of the battery pack of FIG. 3, in which some of the components are disassembled.

FIG. 16 is a bottom view of a first upper plate.

FIG. 17 is a view illustrating a cross-sectional configuration taken along the cutting line E-E' in FIG. 14.

FIG. 18 is a view illustrating a cross-sectional configuration taken along the cutting line A-A' in FIG. 1.

FIG. 19 is a view of the portion F of FIG. 18, in an enlarged scale.

FIG. 20 is a view of the portion F of FIG. 18, in an enlarged scale when a thermal event has occurred.

FIG. 21 is a view of the portion G of FIG. 18, in an enlarged scale.

FIG. 22 is a view of the portion G of FIG. 18, in an enlarged scale when a thermal event has occurred.

FIG. 23 is a view of the portion H of FIG. 18, in enlarged scale.

FIG. 24 is a view of the portion H of FIG. 18, in an enlarged scale when a thermal event has occurred.

FIG. 25 is a view of the portion I of FIG. 18, in enlarged scale.

FIG. 26 is a view of the portion I of FIG. 18, in an enlarged scale when a thermal event has occurred.

FIG. 27 is a view illustrating the flows in a discharge passage and a first cooling passage.

FIG. 28 is a view illustrating a vehicle according to an aspect of the present disclosure.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to accompanying drawings. Prior to this, terms or words used in the present specification and claims should not be limitedly construed as usual or dictionary meanings, and should be interpreted as meanings and concepts consistent with the technical idea of the present disclosure on the basis of the principle that the inventor can appropriately define the concept of the term in order to explain his/her own invention in the best way.

Therefore, the embodiment described in this specification and the configurations illustrated in drawings are merely examples of the present disclosure, and do not represent all of technical ideas of the present disclosure. Thus, it should be understood that there may be various equivalents and modifications that can replace them at the time of filing this application.

In one embodiment of the present disclosure, provided are a battery pack and a pack case, in which when a thermal event occurs, a cooling liquid can be quickly injected into a battery module, and at the same time, the thermal stability and the electrical stability of the battery pack are improved.

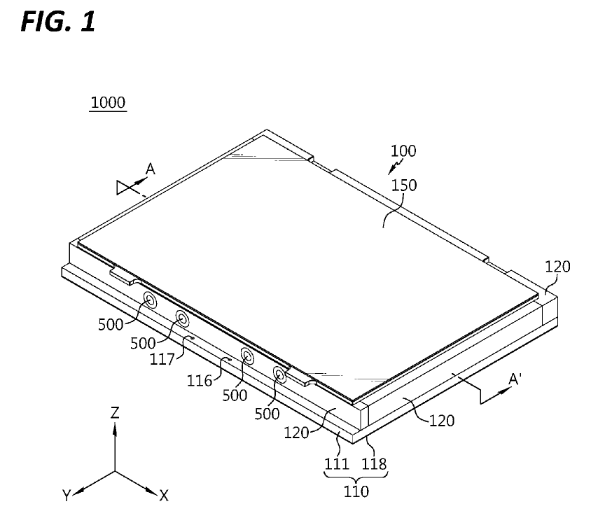

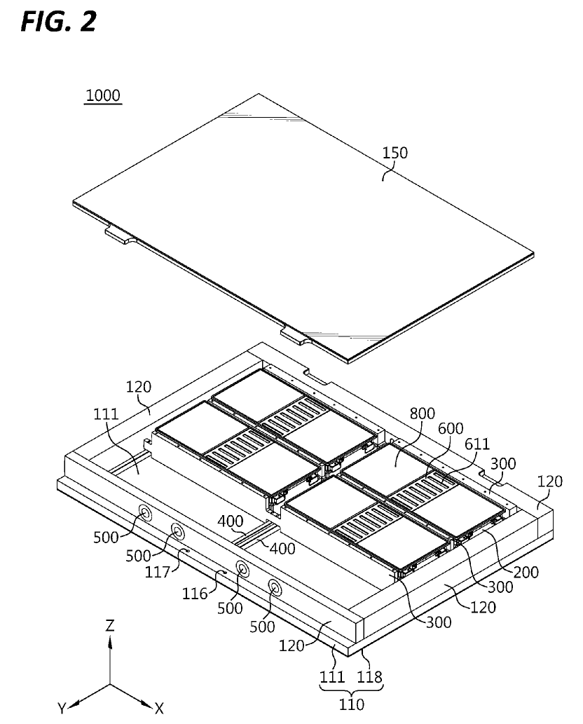

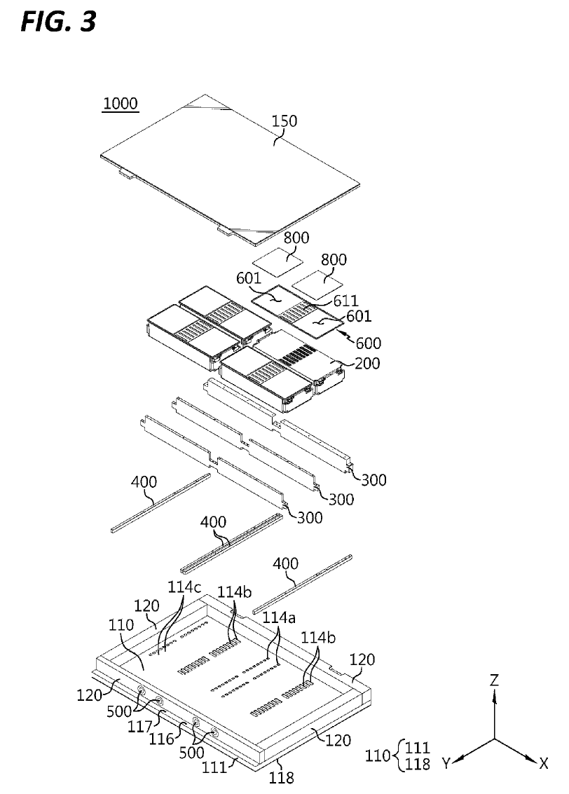

FIG. 1 is a view illustrating a battery pack 1000 according to one embodiment of the present disclosure. FIG. 2 is a view of the battery pack 1000 of FIG. 1, in which some of the components are disassembled. FIG. 3 is a view of the battery pack 1000 of FIG. 2, in which some of the components are disassembled.

Referring to FIGS. 1 to 3, a pack case 100 may provide a space therein. The pack case 100 may include a bottom cover assembly 110. The bottom cover assembly 110 may have a rectangular shape. The bottom cover assembly 110 may have a flat-plate shape. The bottom cover assembly 110 may form the exterior of the battery pack 1000. The bottom cover assembly 110 may provide an internal space of the battery pack 1000.

The pack case 100 may include a side wall 120. The side wall 120 may be installed, fastened, fixed, coupled or attached to the upper surface of the bottom cover assembly 110. The side wall 120 may be provided along the perimeter of the bottom cover assembly 110. For example, the side wall 120 may be provided as four walls. The side wall 120 may provide the internal space of the battery pack 1000.

The pack case 100 may include a top cover assembly 150. The top cover assembly 150 may have a rectangular plate shape. The top cover assembly 150 may have a flat-plate shape. The top cover assembly 150 may form the exterior of the battery pack 1000. The top cover assembly 150 may cover the internal space of the battery pack 1000. The top cover assembly 150 may be installed, fastened, fixed, coupled or attached to the side wall 120.

The battery pack 1000 according to one embodiment of the present disclosure may include a partition wall 300. A plurality of partition walls 300 may be provided. The partition wall 300 may be installed, fastened, fixed, coupled or attached to the upper surface of the bottom cover assembly 110. The partition wall 300 may partition the internal space of the battery pack 1000. The partition wall 300 may extend along the front-rear direction or the X-axis direction. The partition walls 300 may be arranged along the left-right direction or the Y-axis direction.

The battery pack 1000 according to one embodiment of the present disclosure may include an installation beam 400. A plurality of installation beams 400 may be provided. The installation beam 400 may be installed, fastened, fixed, coupled or attached to the upper surface of the bottom cover assembly 110. The installation beam 400 may partition the internal space of the battery pack 1000. The installation beam 400 may extend along the left-right direction or the Y-axis direction. The installation beams 400 may be arranged along the front-rear direction or the X-axis direction.

A battery module 200 may be disposed inside the pack case 100. The battery module 200 may be installed, fastened, fixed, coupled or attached to the upper surface of the bottom cover assembly 110. The battery module 200 may be installed, fastened, fixed, coupled or attached to the installation beam 400. A plurality of battery modules 200 may be provided. For example, four battery modules 200 may be provided. The battery modules 200 may be positioned in spaces defined by the partition walls 300.

A venting device 500 may be installed on the side wall 120. For example, the venting device 500 may be installed on the left side wall 120. For example, the venting device 500 may be a gas valve. When the pressure inside the pack case 100 increases, the venting device 500 may be opened to discharge gas. Also, the venting device 500 may block the external air from flowing into the pack case 100. A plurality of venting devices 500 may be provided.

A third heat transfer member 800 may be disposed between the top cover assembly 150 and the battery module 200. The third heat transfer member 800 may be provided for each battery module 200. For example, the third heat transfer member 800 may include a material with high thermal conductivity. For example, the third heat transfer member 800 may include resin.

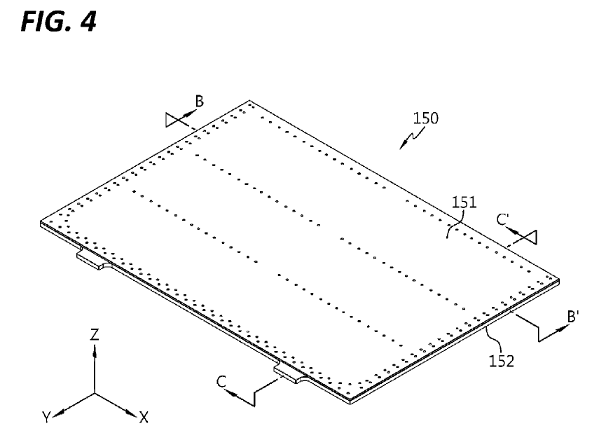

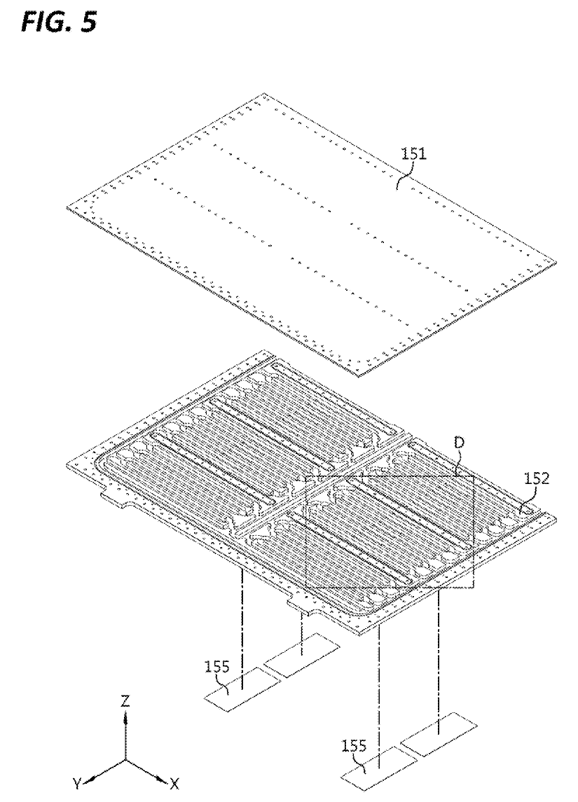

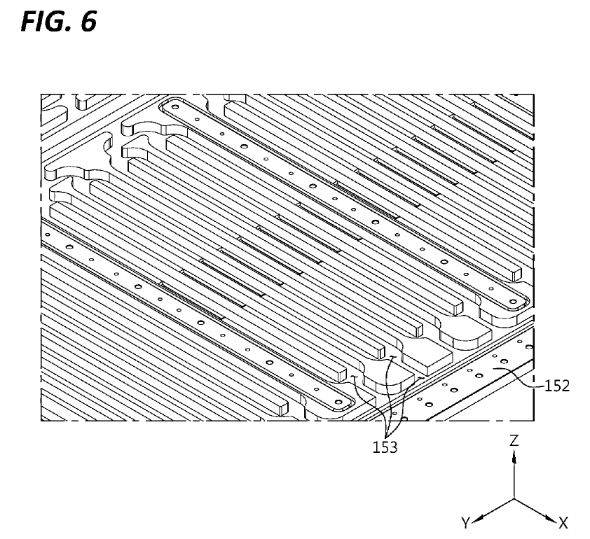

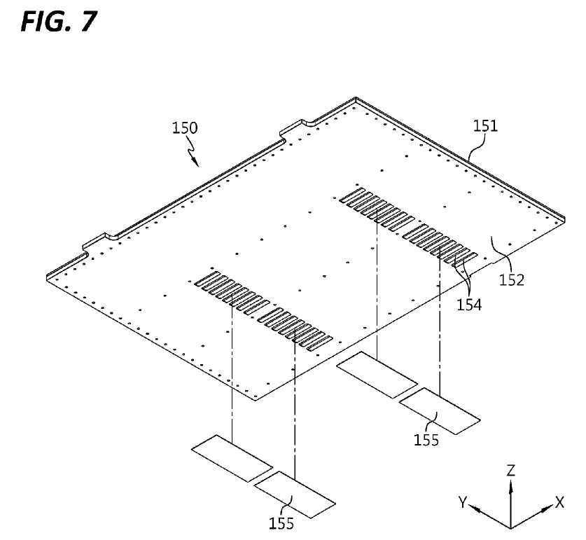

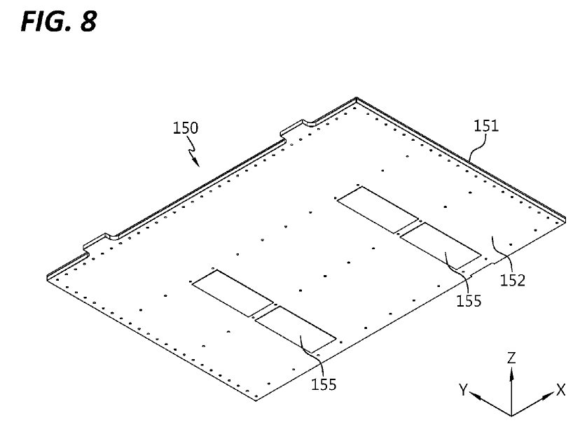

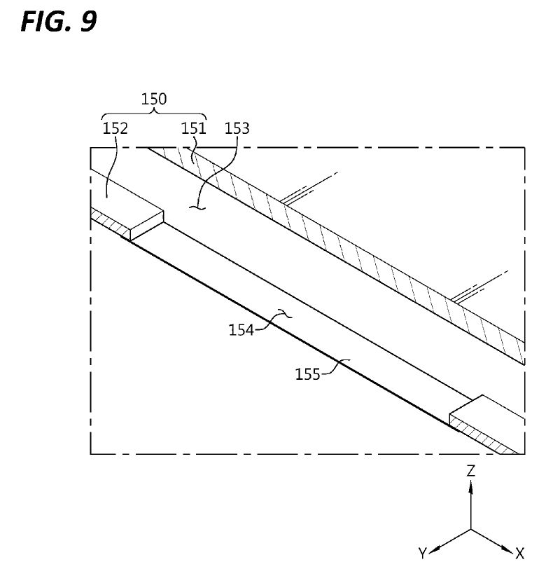

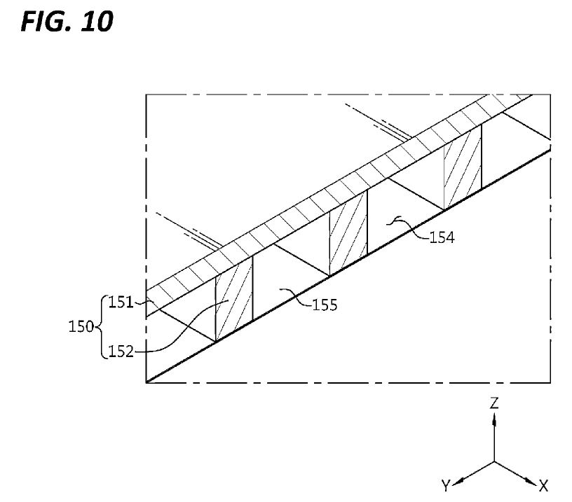

FIG. 4 is a view illustrating the top cover assembly 150 of FIG. 3. FIG. 5 is a view of the top cover assembly 150 of FIG. 4, in which some of the components are disassembled. FIG. 6 is a view of the portion D of FIG. 5, in an enlarged scale. FIG. 7 is a bottom perspective view of FIG. 5. FIG. 8 is a bottom perspective view of the top cover assembly 150 of FIG. 4. FIG. 9 is a view illustrating a cross-sectional configuration taken along the cutting line B-B' in FIG. 4. FIG. 10 is a view illustrating a cross-sectional configuration taken along the cutting line C-C' in FIG. 4.

Referring to FIGS. 4 to FIG. 10, the top cover assembly 150 according to one embodiment of the present disclosure may include a second upper plate 151 and a second lower plate 152. The second upper plate 151 may have a rectangular shape. The second upper plate 151 may form the exterior of the battery pack 1000. The second lower plate 152 may have a rectangular shape. The second lower plate 152 may form the exterior of the battery pack 1000. The second upper plate 151 may be disposed on the second lower plate 152. The top cover assembly 150 may include a second cooling passage 153 therein. The second cooling passage 153 may be disposed between the second upper plate 151 and the second lower plate 152. The top cover assembly 150 may have an injection hole 154. The injection hole 154 may be formed in the second lower plate 152. The injection hole 154 may communicate with the second cooling passage 153. The injection hole 154 may have a rectangular shape. The injection hole 154 may extend along the front-rear direction or the X-axis direction. A plurality of injection holes 154 may be provided. The injection holes 154 may be arranged along the left-right direction or the Y-axis direction.

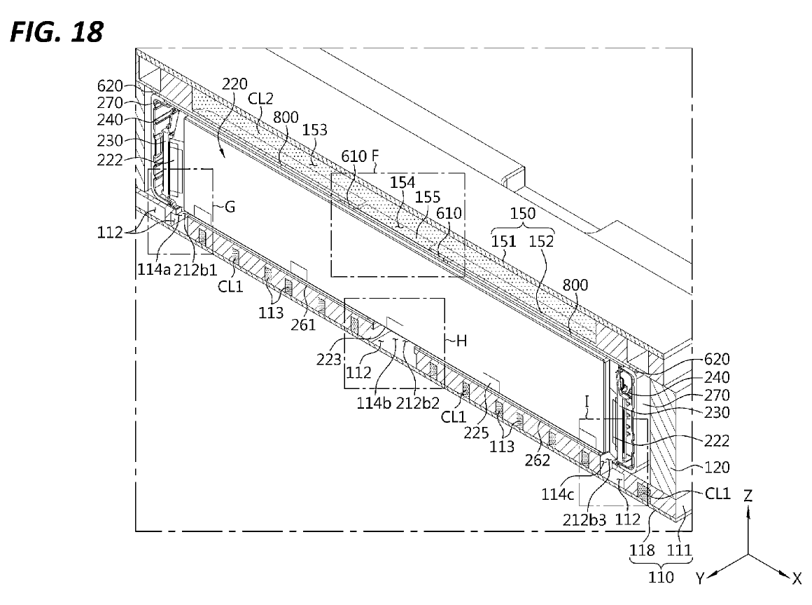

A second cooling liquid CL2 (see, e.g., FIG. 18) may flow through the second cooling passage 153. The second cooling liquid CL2 may cool heat generated from the battery module 200 while flowing through the second cooling passage 153. For example, the second cooling liquid CL2 may be water.

The top cover assembly 150 may include a hole cover 155. The hole cover 155 may be attached, coupled, fastened or fixed to the lower surface of the second lower plate 152. For example, the hole cover 155 may be fused to the lower surface of the second lower plate 152. The hole cover 155 may seal the injection hole 154. The hole cover 155 may seal the plurality of injection holes 154. The hole cover 155 may have a rectangular shape. The hole cover 155 may have a sheet shape. A plurality of hole covers 155 may be provided. The hole covers 155 may be provided to correspond to the battery modules 200 on a one-to-one basis. For example, in the case of FIGS. 5 and 7, four hole covers 155 are provided corresponding to four battery modules 200.

The hole cover 155 may include a polymer material. For example, the hole cover 155 may include a material with a melting point of 170 ˚C or less. For example, the hole cover 155 may include a polylactic acid (PLA) material.

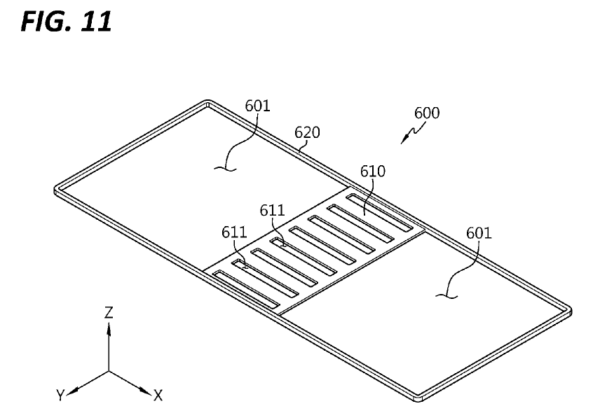

FIG. 11 is a view illustrating a support 600 of FIG. 3.

Referring to FIG. 11, the support 600 may include a first part 610. The first part 610 may have a rectangular shape. A connection hole 611 may extend along the front-rear direction or the X-axis direction. A plurality of connection holes 611 may be provided. The connection holes 611 may be arranged along the left-right direction or the Y-axis direction.

A second part 620 may extend from the first part 610. The second part 620 may extend along the perimeter of the upper surface of the battery module 200. The second part 620 may extend along the perimeter of a top plate 211. The support 600 may have a pair of openings 601. Each opening 601 may be surrounded by the second part 620 and the first part 610. The first part 610 may be positioned between the pair of openings 601. Each opening 601 may have a rectangular shape.

The support 600 may be integrally formed. The first part 610 and the second part 620 may be integrally formed. The support 600 may include an elastic material. For example, the support 600 may include a silicone material. Otherwise, the support 600 may include a metal material. For example, the support 600 may include an aluminum material.

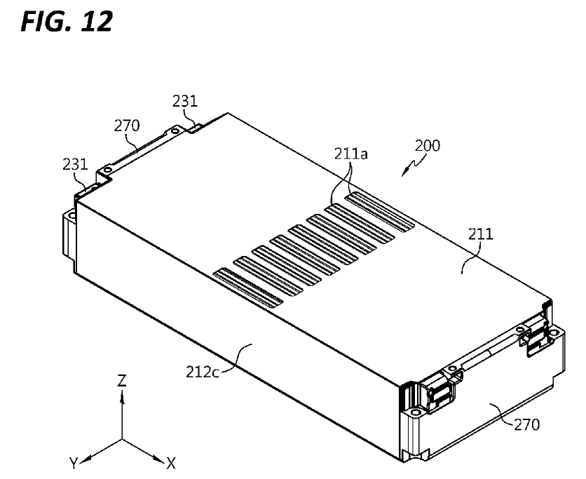

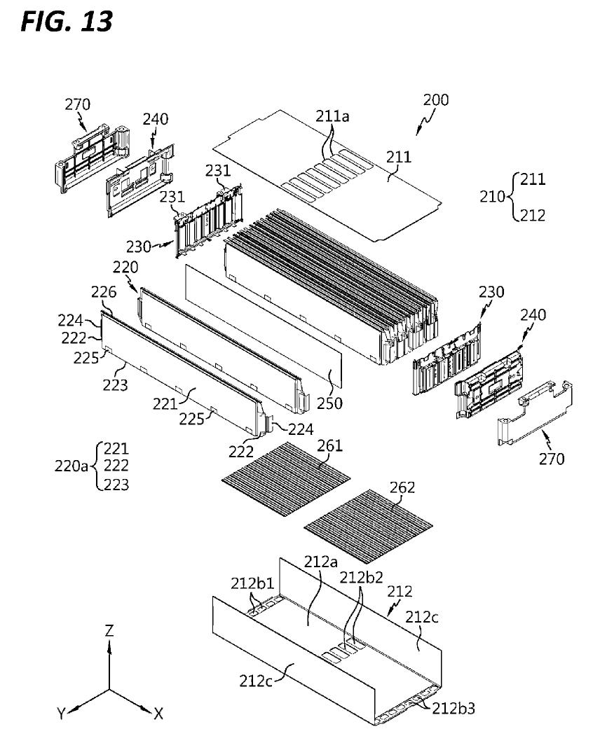

FIG. 12 is a view illustrating the battery module 200 of FIG. 3. FIG. 13 is a view of the battery module 200 of FIG. 12, in which some of the components are disassembled.

Referring to FIGS. 12 and 13, a module case 210 may have a rectangular parallelepiped shape. The module case 210 may form the exterior of the battery module 200. The module case 210 may provide a space therein. The module case 210 may include the top plate 211 and a lower frame 212.

The top plate 211 may have an inflow hole 211a. The inflow hole 211a may extend along the front-rear direction or the X-axis direction. A plurality of inflow holes 211a may be provided. The inflow holes 211a may be arranged along the left-right direction or the Y-axis direction.

A battery cell 220 may be accommodated within the module case 210. A plurality of battery cells 220 may be provided. The battery cell 220 may refer to a secondary battery. For example, the battery cell 220 may be a pouch-type secondary battery. However, the shape of the battery cell 220 is not limited to a pouch shape, and various shapes such as a cylindrical shape or a rectangular parallelepiped shape may be employed.

The battery cell 220 may extend along the front-rear direction or the X-axis direction. The battery cell 220 may include a cell case 220a that provides a space therein. The cell case 220a may include a housing portion 221 including an electrode assembly, a first sealing portion 222 protruding toward each of the front side and the rear side of the housing portion 221, and a second sealing portion 223 protruding downward from the housing portion 221. The first sealing portion 222 and the second sealing portion 223 may be formed through bonding or attachment to the cell case 220a. The upper end of the housing portion 221 of the battery cell 220 may be referred to as a folding portion 226. The folding portion 226 may be formed through folding of the cell case 220a. Also, the battery cell 220 may include electrode leads 224 protruding toward the front side and the rear side of the first sealing portions 222, respectively. The electrode leads 224 may protrude toward the front side and the rear side of each battery cell 220. The battery cells 220 may be stacked along the left-right direction or the Y-axis direction. The battery cell 220 may include an adhesive member 225 by which the second sealing portion 223 is folded and fixed to the housing portion 221. The adhesive member 225 may cause the second sealing portion 223 to come in close contact with the housing portion 221. A plurality of adhesive members 225 may be provided. The adhesive members 225 may be arranged along the front-rear direction or the X-axis direction.

A barrier 250 may be disposed between the battery cells 220. The barrier 250 may be disposed between at least some of the battery cells 220 and/or outside a stack. For example, in the configuration form of the barrier 250, the barrier 250 may be disposed between every two battery cells 220 stacked in the left-right direction.

Such a barrier 250 may include an elastic material so that swelling of the battery cells 220 can be absorbed. For example, the barrier 250 may be made of a foam material such as polyurethane. Otherwise, the barrier 250 may include a material capable of blocking heat, flames, and the like. For example, the barrier 250 may include an insulating or fire-proof material such as silicone or mica.

A front busbar frame assembly 230 may be provided in front of the plurality of battery cells 220. The front busbar frame assembly 230 may be electrically connected to the electrode leads 224 on the front side of the battery cells 220.

A rear busbar frame assembly 230 may be provided at the rear of the plurality of battery cells 220. The rear busbar frame assembly 230 may be electrically connected to the electrode leads 224 on the rear side of the battery cells 220. The rear busbar frame assembly 230 may include a power terminal 231.

The lower frame 212 may include a bottom plate 212a. The battery cell 220 may be disposed between the bottom plate 212a of the lower frame 212 and the top plate 211. For example, the battery cell 220 may be disposed above the bottom plate 212a of the lower frame 212 and under the top plate 211.

The bottom plate 212a may have a first venting hole 212b1. The first venting hole 212b1 may be provided on the front side of the bottom plate 212a. A plurality of first venting holes 212b1 may be provided. The first venting holes 212b1 may be arranged along the left-right direction or the Y-axis direction. The first venting hole 212b1 may face the first sealing portion 222. The first venting hole 212b1 may face the electrode lead 224.

The bottom plate 212a may have a second venting hole 212b2. The second venting hole 212b2 may be provided at the center of the bottom plate 212a. The second venting hole 212b2 may be positioned between the first venting hole 212b1 and a third venting hole 212b3 to be described below. A plurality of second venting holes 212b2 may be provided. The second venting holes 212b2 may be arranged along the left-right direction or the Y-axis direction. The second venting hole 212b2 may face the housing portion 221.

The bottom plate 212a may have the third venting hole 212b3. The third venting hole 212b3 may be provided at the rear side of the bottom plate 212a. A plurality of third venting holes 212b3 may be provided. The third venting holes 212b3 may be arranged along the left-right direction or the Y-axis direction. The third venting hole 212b3 may face the first sealing portion 222. The third venting hole 212b3 may face the electrode lead 224.

When a thermal event occurs in the battery cell 220, venting gas G may be discharged through the first venting hole 212b1, the second venting hole 212b2, and the third venting hole 212b3 of the lower frame 212.

The lower frame 212 may include a side plate 212c. A pair of side plates 212c may be provided. The side plates 212c may be provided on the left and right sides of the bottom plate 212a, respectively. The side plate 212c may extend upward from the bottom plate 212a.

The top plate 211 and the lower frame 212 may be coupled, fastened, attached, or assembled to each other. The top plate 211 may be coupled, fastened, attached or assembled to the pair of side plates 212c of the lower frame 212.

A first heat transfer member 261 may be disposed between the bottom plate 212a of the lower frame 212 and the battery cell 220. The first heat transfer member 261 may be disposed between the housing portion 221 of the battery cell 220 and the bottom plate 212a of the lower frame 212. The first heat transfer member 261 may be disposed between the second sealing portion 223 of the battery cell 220 and the bottom plate 212a of the lower frame 212. The first heat transfer member 261 may be disposed between the first venting hole 212b1 and the second venting hole 212b2 of the bottom plate 212a. For example, the first heat transfer member 261 may include resin with high thermal conductivity. The first heat transfer member 261 may cause the bottom plate 212a and the battery cell 220 to be coupled or attached to each other.

A second heat transfer member 262 may be disposed between the bottom plate 212a of the lower frame 212 and the battery cell 220. The second heat transfer member 262 may be disposed between the housing portion 221 of the battery cell 220 and the bottom plate 212a of the lower frame 212. The second heat transfer member 262 may be disposed between the second sealing portion 223 of the battery cell 220 and the bottom plate 212a of the lower frame 212. The second heat transfer member 262 may be disposed between the third venting hole 212b3 and the second venting hole 212b2 of the bottom plate 212a. For example, the second heat transfer member 262 may include resin with high thermal conductivity. The second heat transfer member 262 may cause the bottom plate 212a of the lower frame 212 and the battery cell 220 to be coupled or attached to each other.

A pair of end covers 270 may be coupled, fastened, attached or assembled to the front side and the rear side of the module case 210, respectively. The pair of end covers 270 may cover the front side and the rear side of the module case 210. The end covers 270 may be coupled, fastened, attached or assembled to the top plate 211. The end covers 270 may be coupled, fastened, attached or assembled to the pair of side plates 212c of the lower frame 212. The end cover 270 may have a rectangular shape. The end cover 270 may form the exterior of the battery module 200.

An insulating cover 240 may be positioned between the end cover 270 and the busbar frame assembly 230. A pair of insulating covers 240 may be provided. The front side insulating cover 240 may be positioned between the front side end cover 270 and the front side busbar frame assembly 230. The rear side insulating cover 240 may be positioned between the rear side end cover 270 and the rear side busbar frame assembly 230. The insulating cover 240 may electrically insulate the busbar frame assembly 230 and the end cover 270 from each other.

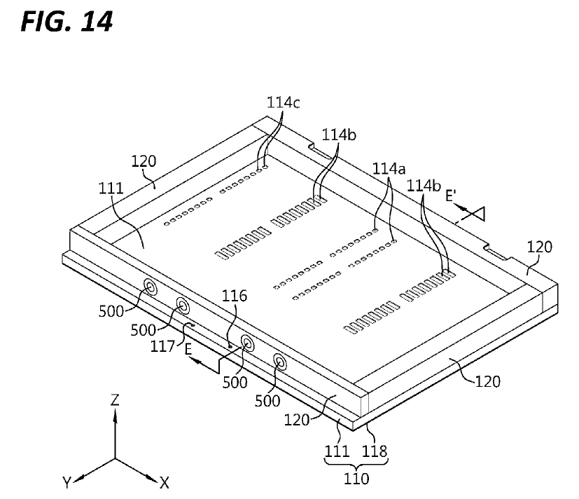

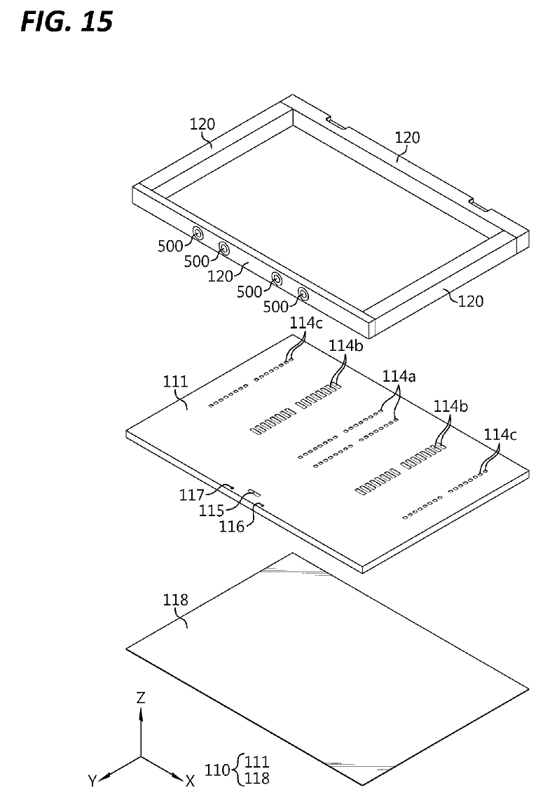

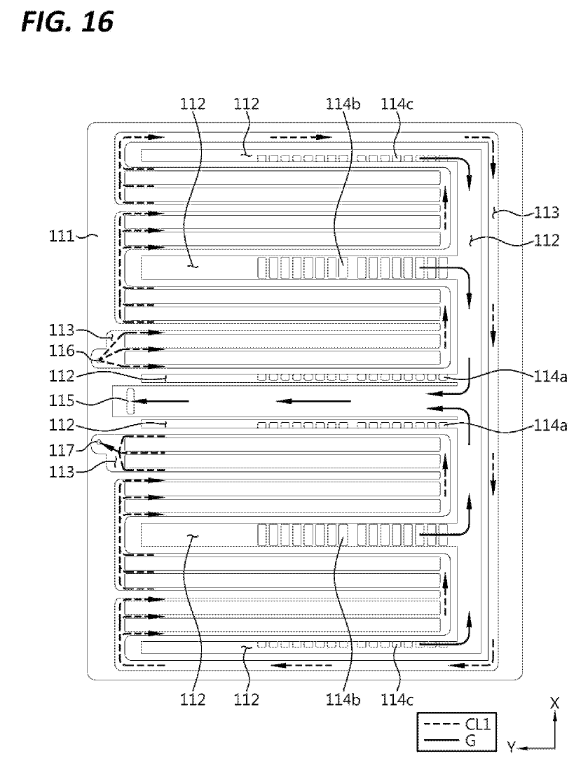

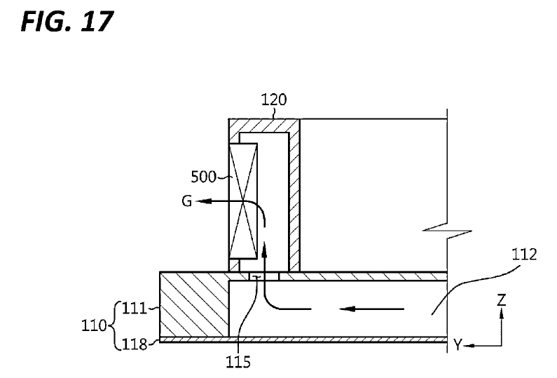

FIG. 14 is a view illustrating some of the components of the battery pack 1000 of FIG. 3. FIG. 15 is a view of the battery pack 1000 of FIG. 3, in which some of the components are disassembled. FIG. 16 is a bottom view of a first upper plate 111. FIG. 17 is a view illustrating a cross-sectional configuration taken along the cutting line E-E' in FIG. 14.

Referring to FIGS. 14 to 17, the bottom cover assembly 110 may include the first upper plate 111 and a first lower plate 118. The first upper plate 111 may have a rectangular shape. The first upper plate 111 may form the exterior of the battery pack 1000. The first lower plate 118 may have a rectangular shape. The first lower plate 118 may form the exterior of the battery pack 1000. The first upper plate 111 may be disposed on the first lower plate 118.

The bottom cover assembly 110 may include a first cooling passage 113 therein. The first cooling passage 113 may be disposed between the first upper plate 111 and the first lower plate 118. The first upper plate 111 may include an inlet 116 and an outlet 117. Each of the inlet 116 and the outlet 117 may communicate with the first cooling passage 113.

The bottom cover assembly 110 may include a discharge passage 112 therein. The discharge passage 112 may be disposed between the first upper plate 111 and the first lower plate 118. The first upper plate 111 may have a first communication hole 114a. The first communication hole 114a may communicate with the discharge passage 112. A plurality of first communication holes 114a may be provided. The first communication holes 114a may be arranged along the left-right direction or the Y-axis direction. The first communication holes 114a of the bottom cover assembly 110 may be provided to correspond to the first venting holes 212b1 of the lower frame 212 on a one-to-one basis. The plurality of first communication holes 114a of the bottom cover assembly 110 may communicate with the plurality of first venting holes 212b1 of the lower frame 212.

The first upper plate 111 of the bottom cover assembly 110 may have a second communication hole 114b. The second communication hole 114b may communicate with the discharge passage 112 formed in the bottom cover assembly 110. A plurality of second communication holes 114b may be provided. The second communication holes 114b may be arranged along the left-right direction or the Y-axis direction. The second communication holes 114b may be provided to correspond to the second venting holes 212b2 of the lower frame 212 on a one-to-one basis. The plurality of second communication holes 114b of the bottom cover assembly 110 may communicate with the plurality of second venting holes 212b2 of the lower frame 212.

The first upper plate 111 of the bottom cover assembly 110 may have a third communication hole 114c. The third communication hole 114c may communicate with the discharge passage 112 formed in the bottom cover assembly 110. A plurality of third communication holes 114c may be provided. The third communication holes 114c may be arranged along the left-right direction or the Y-axis direction. The third communication holes 114c may be provided to correspond to the third venting holes 212b3 of the lower frame 212 on a one-to-one basis. The plurality of third communication holes 114c of the bottom cover assembly 110 may communicate with the plurality of third venting holes 212b3 of the lower frame 212. The third communication hole 114c of the bottom cover assembly 110 may be disposed between the first communication hole 114a and the second communication hole 114b.

The first cooling passage 113 and the discharge passage 112 may be configured independently. For example, the first cooling passage 113 and the discharge passage 112 may not communicate with each other.

A first cooling liquid CL1 may flow through the first cooling passage 113. The first cooling liquid CL1 may cool heat generated from the battery module 200 while flowing through the first cooling passage 113. For example, the first cooling liquid CL1 may be water.

The venting gas G discharged through the first venting hole 212b1, the second venting hole 212b2, and the third venting hole 212b3 formed in the bottom plate 212a which is a part of the lower frame 212 may flow through the discharge passage 112 formed in the bottom cover assembly 110.

The flow of the first cooling liquid CL1 and the flow of the venting gas G may be independently formed. The flow of the first cooling liquid CL1 and the flow of the venting gas G may be separated.

The first upper plate 111 of the bottom cover assembly 110 may have a fourth communication hole 115. The fourth communication hole 115 may communicate with the discharge passage 112 formed in the bottom cover assembly 110. The fourth communication hole 115 may communicate with the side wall 120. The fourth communication hole 115 may communicate with the venting device 500 provided in the side wall 120. The venting gas G, which has flowed into the discharge passage 112 formed in the bottom cover assembly 110, may be discharged to the outside of the battery pack 1000 via the fourth communication hole 115, the side wall 120, and the venting device 500.

FIG. 18 is a view illustrating a cross-sectional configuration taken along the cutting line A-A' in FIG. 1.

Referring to FIG. 3 and FIG. 18, the battery module 200 may be installed, coupled, fastened, fixed or attached to the upper surface of the bottom cover assembly 110. The battery module 200 formed by the plurality of battery cells 220 may be installed, coupled, fastened, fixed or attached to the upper surface of the first upper plate 111. The battery module 200 may be cooled by the first cooling liquid CL1 flowing through the first cooling passage 113.

The battery module 200 may be cooled by the second cooling liquid CL2 flowing through the second cooling passage 153. The third heat transfer member 800 may be disposed between the battery module 200 and the top cover assembly 150. The third heat transfer member 800 may be in contact with, coupled to, or attached to the battery module 200. The third heat transfer member 800 may be in contact with, coupled to, or attached to the top cover assembly 150. The third heat transfer member 800 may be disposed between the top plate 211 and the second lower plate 152. The third heat transfer member 800 may be in contact with, coupled to, or attached to the top plate 211. The third heat transfer member 800 may be in contact with, coupled to, or attached to the second lower plate 152. The third heat transfer member 800 may be disposed in the opening 601. For example, the third heat transfer member 800 may include resin. The first part 610 and the second part 620 may limit the filling range of the third heat transfer member 800. The third heat transfer member 800 may be surrounded by the first part 610 and the second part 620. The heat generated from the battery module 200 may be transferred to the top cover assembly 150 via the third heat transfer member 800.

When a thermal event occurs, the structure of the battery pack 1000 may be damaged. Here, according to the embodiment of the present disclosure, even when either the bottom cover assembly 110 or the top cover assembly 150 is damaged, the cooling of the battery module 200 may be continued. Accordingly, the thermal safety of the battery pack 1000 may be improved.

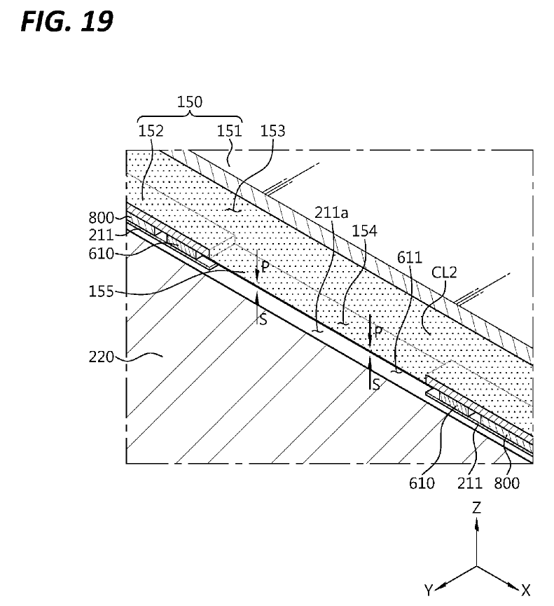

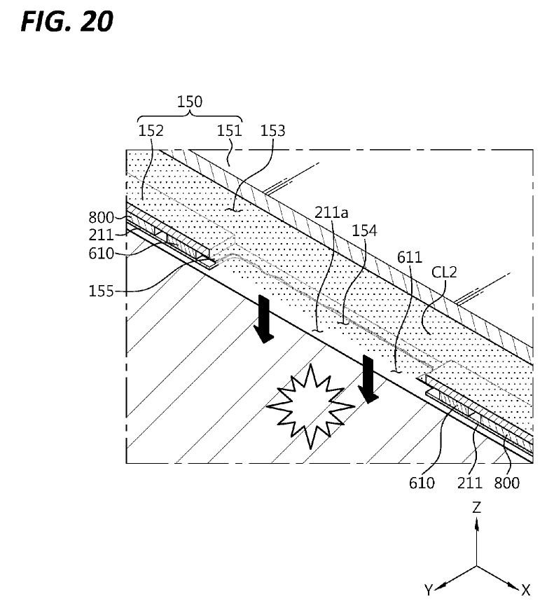

FIG. 19 is a view of the portion F of FIG. 18, in an enlarged scale. FIG. 20 is a view of the portion F of FIG. 18, in an enlarged scale when a thermal event has occurred.

Referring to FIGS. 18 to 20, the support 600 may adhere to the upper surface of the battery module 200, for example, the upper surface of the top plate 211. The support 600 may adhere to the lower surface of the top cover assembly 150, for example, the lower surface of the second lower plate 152.

When the support 600 includes a metal material, the support 600 may be coupled to the upper surface of the battery module 200, for example, the upper surface of the top plate 211 by brazing. When the support 600 includes a metal material, the support 600 may be coupled to the lower surface of the top cover assembly 150, for example, the lower surface of the second lower plate 152, by brazing.

According to one embodiment, when the support 600 includes a metal material, the support 600 may be formed integrally with the battery module 200.

The hole cover 155 may seal the injection hole 154. The interior of the second cooling passage 153 may be filled with the second cooling liquid CL2. The second cooling liquid CL2 may flow along the second cooling passage 153. The hole cover 155 may seal the injection hole 154 so as to prevent the second cooling liquid CL2 from leaking through the injection hole 154.

According to one embodiment, the injection hole 154 may be positioned above the battery cell 220. The injection hole 154 may face the connection hole 611. The hole cover 155 may be disposed between the injection hole 154 and the connection hole 611. The support 600 may be disposed on the lower surface of the hole cover 155.

The support 600 may be fixed between the top cover assembly 150 and the battery module 200. For example, the support 600 may be fixed between the second lower plate 152 of the top cover assembly 150 and the top plate 211. The first part 610 may be fixed between the hole cover 155 of the top cover assembly 150 and the top plate 211. The first part 610 may be compressed between the hole cover 155 and the top plate 211. The support 600 may support the hole cover 155. The first part 610 may support the hole cover 155.

The hole cover 155 may be subjected to pressure P from the second cooling liquid CL2 flowing through the second cooling passage 153. The first part 610 may support the hole cover 155. The first part 610 may provide a supporting force S to the hole cover 155. The first part 610 may support the hole cover 155 so as to prevent the hole cover 155 from being sagged or deformed by the pressure P of the second cooling liquid CL2. Due to the first part 610, the hole cover 155 may stably seal the injection hole 154.

The injection hole 154 may face the connection hole 611. The hole cover 155 may be disposed between the injection hole 154 and the connection hole 611. The support 600 may be disposed on the lower surface of the hole cover 155.

The connection hole 611 may face the inflow hole 211a. The connection hole 611 may communicate with the inflow hole 211a. The connection hole 611 may have substantially the same size as the inflow hole 211a. The diameter of the connection hole 611 may be substantially the same as the diameter of the inflow hole 211a. The inflow hole 211a may face the hole cover 155.

According to one embodiment, the connection hole 611 may have substantially the same size as the injection hole 154. The diameter of the connection hole 611 may be substantially the same as the diameter of the injection hole 154. Accordingly, when a thermal event occurs, the hole cover 155 may be easily melted or damaged. As a sealing portion 222, 223 is melted or damaged, the injection hole 154, the connection hole 611, and the inflow hole 211a communicate with each other. The second cooling liquid CL2 may flow into the battery module 200 through the injection hole 154, the connection hole 611, and the inflow hole 211a. Accordingly, it is possible to quickly cool and extinguish a thermal event, for example, the battery cell 220 in which a fire has occurred.

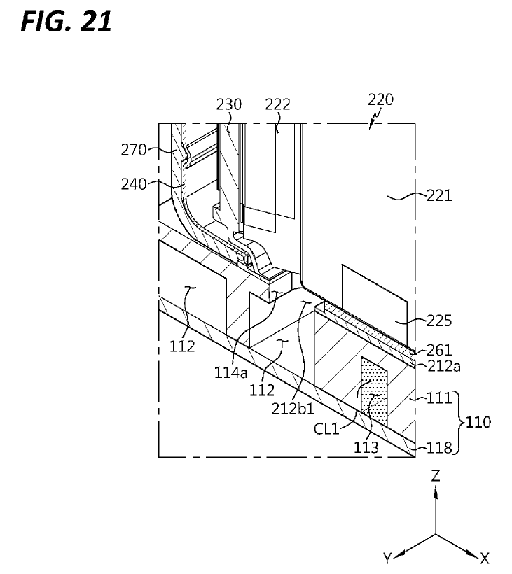

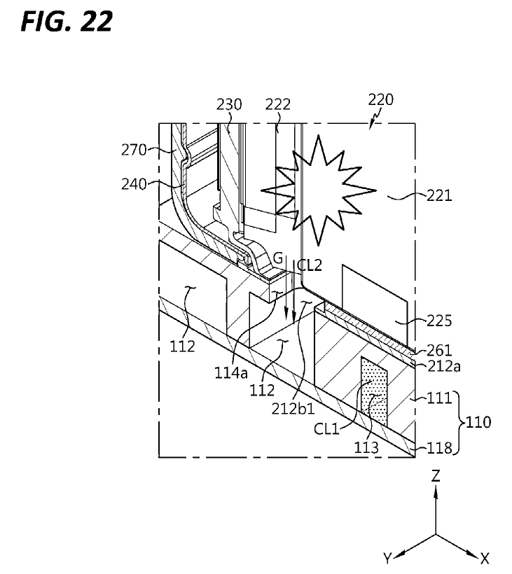

FIG. 21 is a view of the portion G of FIG. 18, in an enlarged scale. FIG. 22 is a view of the portion G of FIG. 18, in an enlarged scale when a thermal event has occurred.

Referring to FIG. 18, FIG. 21, and FIG. 22, the first communication hole 114a of the bottom cover assembly 110 may face the first venting hole 212b1 of the lower frame 212. Due to this structure, the first communication hole 114a of the bottom cover assembly 110 may face the battery cell 220. The first communication hole 114a of the bottom cover assembly 110 may face the first sealing portion 222 of the battery cell 220. Also, the first communication hole 114a of the bottom cover assembly 110 may face the electrode lead 224 of the battery cell 220.

When a thermal event occurs, the venting gas G generated from the battery cell 220 may flow into the discharge passage 112 formed in the bottom cover assembly 110, through the first venting hole 212b1 of the lower frame 212 and the first communication hole 114a of the bottom cover assembly 110. The venting gas G flowing into the discharge passage 112 may be discharged to the outside of the battery pack 1000, through the fourth communication hole 115, the side wall 120, and the venting device 500.

When a thermal event occurs, the second cooling liquid CL2, which has flowed into the battery module 200, may flow into the discharge passage 112 formed in the bottom cover assembly 110, through the first venting hole 212b1 of the lower frame 212 and the first communication hole 114a of the bottom cover assembly 110. When the second cooling liquid CL2 remains inside the battery module 200, troubles such as an electrical short may be caused. However, due to the first venting hole 212b1 of the lower frame 212 and the first communication hole 114a of the bottom cover assembly 110, the second cooling liquid CL2 may quickly cool the battery cell 220 of the battery module 200, and flow into the discharge passage 112 formed in the bottom cover assembly 110, so that electrical troubles may not be caused. Accordingly, it is possible to improve the thermal stability and electrical stability of the battery pack 1000.

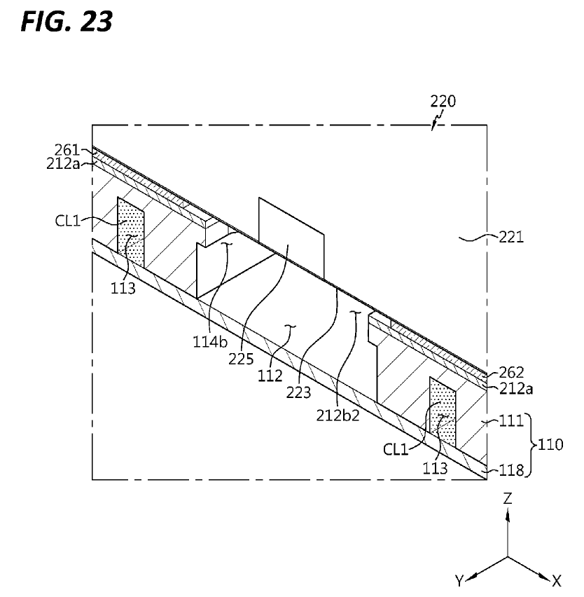

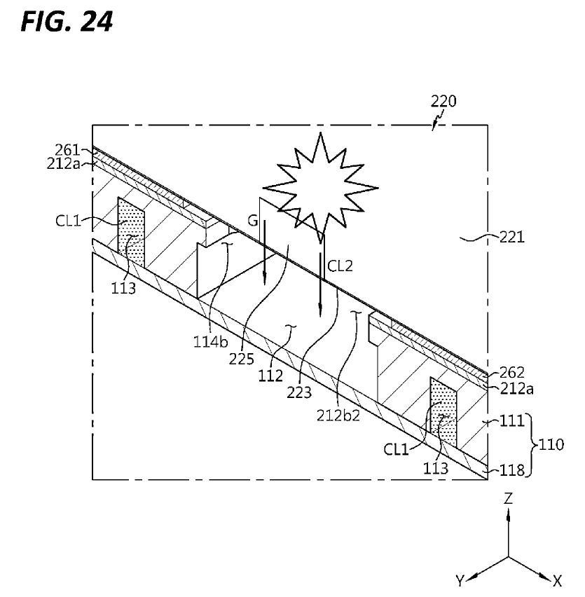

FIG. 23 is a view of the portion H of FIG. 18, in an enlarged scale. FIG. 24 is a view of the portion H of FIG. 18, in an enlarged scale when a thermal event has occurred.

Referring to FIG. 18, FIG. 23, and FIG. 24, the second communication hole 114b of the bottom cover assembly 110 may face the second venting hole 212b2 of the lower frame 212. Due to this structure, the second communication hole 114b of the bottom cover assembly 110 may face the battery cell 220. The second communication hole 114b of the bottom cover assembly 110 may face the housing portion 221 and the second sealing portion 223 of the battery cell 220.

When a thermal event occurs, the venting gas G may flow into the discharge passage 112 formed in the bottom cover assembly 110, through the second venting hole 212b2 of the lower frame 212 and the second communication hole 114b of the bottom cover assembly 110. The venting gas G flowing into the discharge passage 112 may be discharged to the outside of the battery pack 1000, through the fourth communication hole 115, the side wall 120, and the venting device 500.

When a thermal event occurs, the second cooling liquid CL2, which has flowed into the battery module 200, may flow into the discharge passage 112 formed in the bottom cover assembly 110, through the second venting hole 212b2 of the lower frame 212 and the second communication hole 114b of the bottom cover assembly 110. When the second cooling liquid CL2 remains inside the battery module 200, troubles such as an electrical short may be caused. However, due to the second venting hole 212b2 of the lower frame 212 and the second communication hole 114b of the bottom cover assembly 110, the second cooling liquid CL2 may quickly cool the battery cell 220 and flow into the discharge passage 112 formed in the bottom cover assembly 110, so that electrical troubles may not be caused. Accordingly, it is possible to improve the thermal stability and electrical stability of the battery pack 1000.

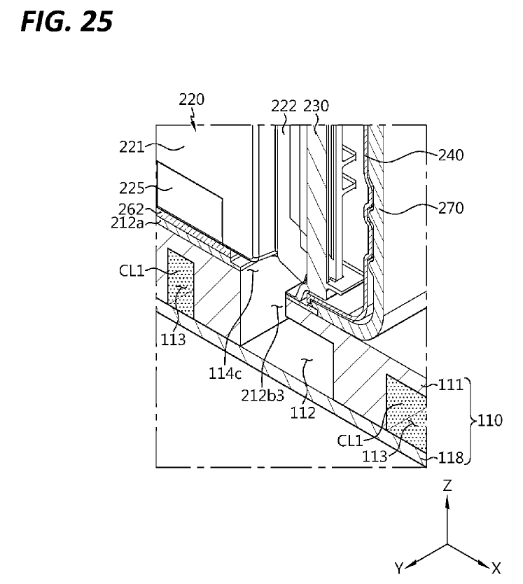

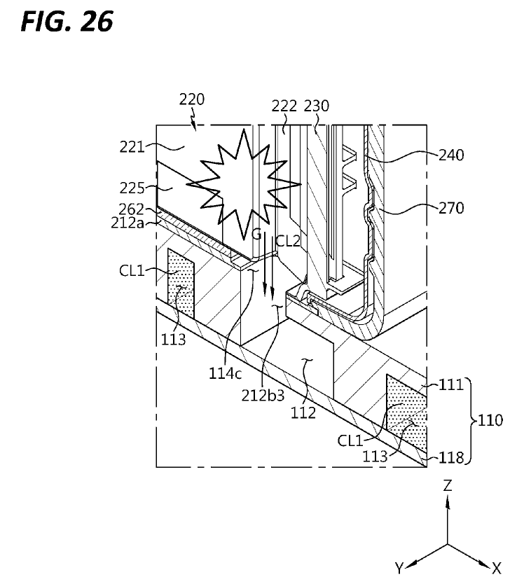

FIG. 25 is a view of the portion I of FIG. 18, in an enlarged scale. FIG. 26 is a view of the portion I of FIG. 18, in an enlarged scale when a thermal event has occurred.

Referring to FIG. 18, FIG. 25, and FIG. 26, the third communication hole 114c of the bottom cover assembly 110 may face the third venting hole 212b3 of the lower frame 212. Due to this structure, the third communication hole 114c of the bottom cover assembly 110 may face the battery cell 220. For example, the third communication hole 114c of the bottom cover assembly 110 may face the first sealing portion 222 and the electrode lead 224 of the battery cell 220.

When a thermal event occurs, the venting gas G may flow into the discharge passage 112 formed in the bottom cover assembly 110, through the third venting hole 212b3 of the lower frame 212 and the third communication hole 114c of the bottom cover assembly 110. The venting gas G flowing into the discharge passage 112 may be discharged to the outside of the battery pack 1000 through the fourth communication hole 115, the side wall 120, and the venting device 500.

When a thermal event occurs, the second cooling liquid CL2, which has flowed into the battery module 200, may flow into the discharge passage 112 formed in the bottom cover assembly 110, through the third venting hole 212b3 of the lower frame 212 and the third communication hole 114c of the bottom cover assembly 110. When the second cooling liquid CL2 remains inside the battery module 200, troubles such as an electrical short may be caused. However, due to the third venting hole 212b3 of the lower frame 212 and the third communication hole 114c of the bottom cover assembly 110, the second cooling liquid CL2 may quickly cool the battery cell 220 and flow into the discharge passage 112 formed in the bottom cover assembly 110, so that electrical troubles may not be caused. Accordingly, it is possible to improve the thermal stability and electrical stability of the battery pack 1000.

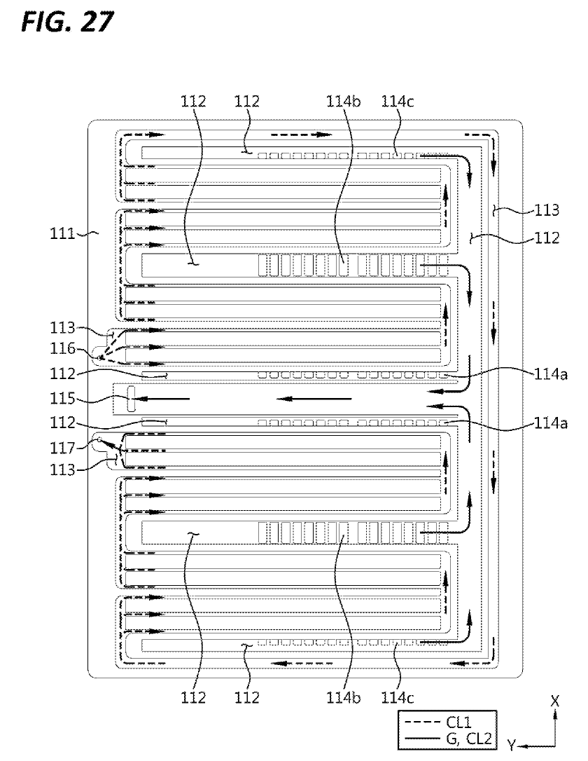

FIG. 27 is a view illustrating the flows in the discharge passage 112 and the first cooling passage 113.

Referring to FIG. 27, when a thermal event occurs, the venting gas G and the second cooling liquid CL2 discharged through the first venting hole 212b1, the second venting hole 212b2, and the third venting hole 212b3 of the lower frame 212 may flow through the discharge passage 112 formed in the bottom cover assembly 110.

The flows of the first cooling liquid CL1 and the venting gas G may be formed independently of each other and then the flows may be separated. Also, the flows of the first cooling liquid CL1 and the second cooling liquid CL2 may be formed independently of each other and then the flows may be separated.

When a thermal event occurs, the second cooling liquid CL2 is injected into the battery module 200 and flows into the discharge passage 112 formed in the bottom cover assembly 110, thereby reducing the cooling function of the top cover assembly 150. Here, even when the cooling function of the top cover assembly 150 is reduced, the first cooling liquid CL1 may flow through the first cooling passage 113 while cooling the heat generated from the battery module 200. Accordingly, it is possible to improve the thermal stability and electrical stability of the battery pack 1000.

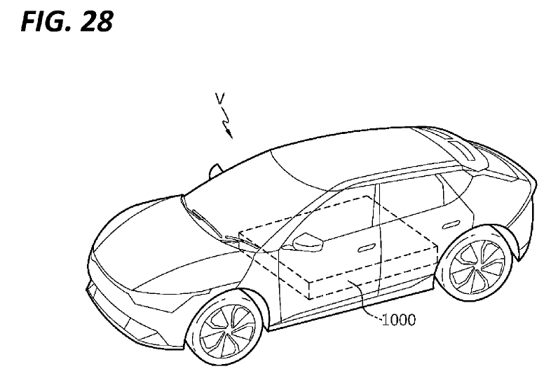

FIG. 28 is a view illustrating a vehicle V according to one aspect of the present disclosure.

Referring to FIG. 28, the battery pack 1000 according to the present disclosure may be applied to a vehicle V such as an electric vehicle or a hybrid vehicle. The vehicle V according to the present disclosure may include the battery pack 1000 according to one embodiment of the present disclosure. Also, the vehicle V according to the present disclosure may further include various other components included in the vehicle, in addition to such a battery pack 1000. For example, the vehicle V according to the present disclosure may further include a vehicle body, a motor, a control device such as an electronic control unit (ECU), and the like.

Meanwhile, although terms indicating directions, such as up, down, left, right, front, and back, have been used in the present specification, it is obvious to those skilled in the art of the present disclosure that these terms are only for convenience of explanation and may vary depending on the location of a target object, the location of an observer, and the like.

As described above, although the present disclosure has been described by limited embodiments and drawings, the present disclosure is not limited thereto. It is obvious that various modifications and changes can be made within the scope of the technical idea of the present disclosure and the equivalent scope of the patent claims to be described below, by a person having ordinary knowledge in the technical field to which the present disclosure pertains.

What is claimed is:

1. A battery pack comprising:
a bottom cover assembly including a communication hole formed in an upper surface thereof, a discharge passage in communication with the communication hole, and a first cooling passage;
a battery cell positioned above the bottom cover assembly;
a top cover assembly positioned above the battery cell and including an injection hole formed in a lower surface thereof and a second cooling passage in communication with the injection hole; and
a hole cover coupled to the lower surface of the top cover assembly and configured to seal the injection hole.

2. The battery pack according to claim 1, further comprising:
a first cooling liquid disposed in the first cooling passage.

3. The battery pack according to claim 1, further comprising:
a side wall provided in the bottom cover assembly; and
a venting device provided in the side wall,
wherein the discharge passage is in communication with the venting device.

4. The battery pack according to claim 1, further comprising:
a second cooling liquid disposed in the second cooling passage.

5. The battery pack according to claim 1, wherein the communication hole faces the battery cell.

6. The battery pack according to claim 1, wherein the injection hole is positioned above the battery cell.

7. The battery pack according to claim 1, wherein the discharge passage and the first cooling passage are configured independently.

8. The battery pack according to claim 1, further comprising:
a module case positioned between the bottom cover assembly and the top cover assembly, and defining a space therein,
wherein the battery cell is accommodated inside the module case.

9. The battery pack according to claim 8, wherein the module case has an inflow hole formed on an upper surface thereof and facing the hole cover.

10. The battery pack according to claim 8, wherein the module case has a venting hole formed on a lower surface thereof and in communication with the communication hole.

11. The battery pack according to claim 10, wherein the venting hole faces the battery cell.

12. The battery pack according to claim 11, wherein the battery cell includes:
a housing portion including an electrode assembly;
a sealing portion extending from the housing portion; and
an electrode lead protruding from the sealing portion,
wherein the venting hole is positioned under the sealing portion.

13. A pack case for a battery pack, the pack case comprising:
a bottom cover assembly and a top cover assembly coupled to the bottom cover assembly, on the bottom cover assembly,
wherein the bottom cover assembly includes: a communication hole formed in the upper surface thereof; a discharge passage in communication with the communication hole; and a first cooling passage designed to allow a first cooling liquid to flow therethrough,
the top cover assembly includes: an injection hole formed in the lower surface thereof and configured to allow a second cooling liquid to be injected into the battery pack accommodated in the lower portion; and a second cooling passage in communication with the injection hole, and
the top cover assembly includes a hole cover coupled to the lower surface thereof and sealing the injection hole.

14. The pack case according to claim 13, wherein the hole cover includes a material having a melting point of a specific temperature or less.

15. The pack case according to claim 14, wherein the hole cover includes polylactic acid (PLA).

16. The pack case according to claim 13, wherein the discharge passage provided in the bottom cover assembly is connected to an outside via a venting device and allows venting gas G flowing into the discharge passage, to be discharged to the outside.

17. A vehicle comprising the battery pack according to claim 1.
